(19) United States
(12) Patent Application Publication
(10) Pub. No.: US 2022/0063607 A1
(43) Pub. Date: Mar. 3, 2022

(54) SYSTEM AND METHOD FOR ADJUSTING DRIVER ASSIST FUNCTIONS BASED ON DISTRACTION LEVEL OF DRIVER

(71) Applicant: AVL Powertrain Engineering, Inc., Plymouth, MI (US)

(72) Inventors: Timothy Daniel, Dearborn, MI (US); Andrew ROBERTS, Northville, MI (US); Scott KARL, Rochester, MI (US)

(21) Appl. No.: 17/458,214

(22) Filed: Aug. 26, 2021

Related U.S. Application Data
(60) Provisional application No. 63/071,702, filed on Aug. 28, 2020.

(51) Int. Cl. B60W 30/09; B60W 50/14; B60W 30/18; B60W 50/16; B60W 30/16; B60W 10/20; B60W 10/04; B60W 10/18; B60W 50/00

(52) U.S. Cl. CPC B60W 30/09; B60W 2554/802; B60W 30/18163; B60W 50/16; B60W 30/16; B60W 10/20; B60W 10/04; B60W 10/18; B60W 50/0097; B60W 2540/229; B60W 2552/53; B60W 2552/05; B60W 2540/10; B60W 2540/18; B60W 2710/202; B60W 2710/182; B60W 50/14

(57) ABSTRACT

A system including a driver distraction module configured to determine a distraction level of a driver of a vehicle and a driver assist module configured to (i) monitor a parameter including at least one of a position of an object relative to the vehicle and a position of at least one boundary of a lane in which the vehicle is travelling, (ii) adjust an actuator of the vehicle to at least one of (a) steer the vehicle and (b) decelerate the vehicle, (iii) control a user interface device of the vehicle to at least one of (a) generate a first message notifying the driver of the object and (b) generate a second message notifying the driver of a possible departure of the vehicle from the lane, and (iv) based on the driver distraction level, adjust operating parameters of the vehicle.

### CROSS REFERENCE TO RELATED APPLICATIONS

This application claims priority under 35 U.S.C. § 119(e) to U.S. Provisional Application 63/071,702, filed on Aug. 28, 2020. The disclosure of this prior application is considered part of the disclosure of this application and is hereby incorporated by reference in its entirety.

### FIELD

The present disclosure relates to systems and methods for adjusting driver assist functions based on a distraction level of a driver.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Modern vehicle control systems perform driver assist functions such as autonomous emergency braking, forward collision warning, adaptive cruise control, lane departure warning, lane keep assist, lane centering control, lane change warning, lane change assist, front cross traffic alert and/or braking, and highway pilot. Autonomous emergency braking involves applying a brake actuator to decelerate a vehicle to avoid or mitigate an impact with an object ahead of the vehicle. Forward collision warning involves notifying a driver of a potential impact with an object ahead of the vehicle.

Adaptive cruise control involves adjusting the speed of a vehicle to maintain a set speed selected by the driver and a following distance or time gap to another vehicle. Lane departure warning involves notifying a driver when a vehicle is about to depart or has departed from a lane in which the vehicle is travelling without the intention of the driver. Lane keep assist involves adjusting the path of a vehicle to prevent the vehicle from departing from a lane in which the vehicle is travelling without the intention of the driver.

Lane centering control involves adjusting the path of a vehicle to maintain the centerline of the vehicle aligned with the centerline of a lane in which the vehicle is travelling. Lane change warning involves notifying a driver of an object within a future path of a vehicle during a lane change, such as in a blind spot of the vehicle. Lane change assist involves adjusting the speed and path of a vehicle to perform a highway lane change maneuver when instructed to do so by a driver.

Front cross traffic alert involves notifying a driver of a vehicle when another vehicle is crossing a forward path of the vehicle where a potential impact is imminent. Front cross traffic alert with braking involves applying a brake actuator to decelerate a vehicle when another vehicle is crossing a forward path of the vehicle and a potential impact is imminent. Highway pilot involves controlling brake, acceleration, and steering actuators to adjust the speed and path of a vehicle to complete a portion of a route selected by the driver that takes place on a designated highway or other geo-fenced region.

### BRIEF DESCRIPTION OF THE DRAWINGS

The present disclosure will become more fully understood from the detailed description and the accompanying drawings, wherein:

FIG. 1 is a schematic of an example vehicle according to the present disclosure;

FIG. 2 is a functional block diagram of an example vehicle control module according to the present disclosure;

FIG. 3 is a flowchart illustrating an example method for determining a distraction level of a driver according to the present disclosure;

FIG. 4 is a flowchart illustrating an example method for adjusting forward collision warning and mitigation functions based on the driver distraction level according to the present disclosure;

FIG. 5 is a flowchart illustrating an example method for adjusting lane keep assist and lane departure warning functions based on the driver distraction level according to the present disclosure;

FIG. 6 is a flowchart illustrating an example method for adjusting lane centering control based on the driver distraction level according to the present disclosure;

FIG. 7 is a flowchart illustrating an example method for adjusting lane departure warning and lane change assist functions based on the driver distraction level according to the present disclosure;

FIG. 8 is a flowchart illustrating an example method for adjusting adaptive cruise control based on the driver distraction level according to the present disclosure; and

FIG. 9 is a flowchart illustrating an example method for adjusting a highway pilot function based on the driver distraction level according to the present disclosure.

In the drawings, reference numbers may be reused to identify similar and/or identical elements.

### DETAILED DESCRIPTION

Driver assist functions such as those discussed above serve several purposes. Some driver assist functions perform tasks of a driver to reduce the amount of effort required to drive a vehicle. These tasks are typically level one or two functions under the level definitions provided by the Society of Automotive Engineers (SAE). Some driver assist functions notify a driver of a potential impact with an object in case the driver does not observe the object. These tasks are typically level zero functions under the SAE level definitions. Some driver assist functions control a vehicle actuator to cause a vehicle to take a corrective action that avoids or mitigates an impact. These tasks are typically level zero, one, or two functions under the SAE level definitions.

Driver assist functions that perform the tasks of a driver may be designed with the assumption that the driver is paying attention to the driving tasks while the driver assist functions are performed. Thus, if a driver becomes distracted while these driver assist functions are performed, the number of redundant safety measures may be less than intended. Diver assist functions that notify a driver of a potential impact and/or control a vehicle actuator to avoid or mitigate an impact are most beneficial when the driver is not paying attention to the vehicle surroundings. However, these driver assist functions may become annoying to a driver that is paying attention, prompting the driver to disable these driver assist functions and thereby eliminating the safety benefits of these driver assist functions.

A vehicle control system according to the present disclosure addresses these issues by adjusting driver assist functions based on a distraction level of a driver. In one example, when the driver distraction level is medium or high, the system disables driver assist functions that perform driving tasks. In turn, the driver is forced to either pay attention to the driving tasks being performed by the vehicle control system or perform those driving tasks himself/herself. In another example, when the driver distraction level is low, the system adjusts driver assist functions that notify a driver of a potential impact by delaying or disabling the notifications or reducing the intensity of the notifications. This reduces the likelihood that the driver will become annoyed with the notifications and therefore disable these driver assist functions. In another example, when the driver distraction level is low, the system adjusts driver assist functions that control a vehicle actuator to avoid or mitigate an impact by delaying, disabling, and/or reducing the magnitude the corrective actions. This reduces the likelihood that the driver will become annoyed with the corrective actions and therefore disable these driver assist functions. In another example, when the driver distraction level is high, the system increases the aggressiveness of one or more driver assist functions that control a vehicle actuator in order to prevent unintended driving maneuvers or impacts such as rear end collisions.

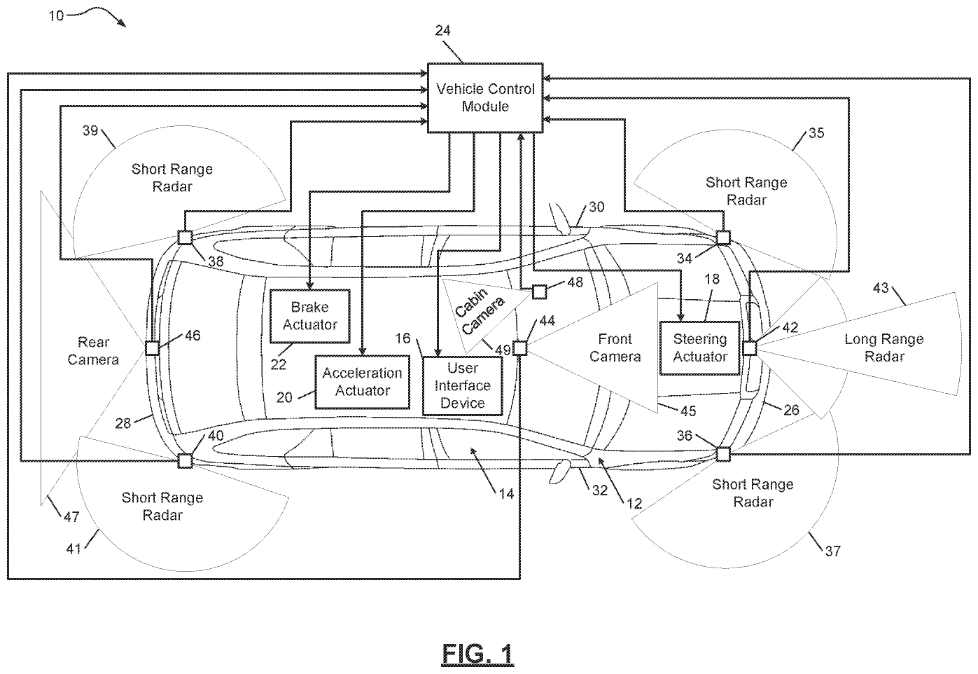

Referring now to FIG. 1, a vehicle 10 includes a vehicle body 12, a cabin 14, a user interface device 16, a steering actuator 18, an acceleration actuator 20, a brake actuator 22, and a vehicle control module 24. The vehicle body 12 has a front end 26, a rear end 28, a left side 30, and a right side 32. The cabin 14 is disposed within the vehicle body 12, and the user interface device 16 is disposed within the cabin 14. A driver of the vehicle 10 sits within the cabin 14 and interacts with the user interface device 16.

The user interface device 16 generates visible messages (e.g., text, images), audible messages, and/or tactile messages (e.g., haptic feedback) providing information to the driver of the vehicle 10. The user interface device 16 may include an electronic display (e.g., a touchscreen) operable to display a visible message and/or to generate electronic signals in response to a user input (e.g., a user touching the touchscreen). In addition, the user interface device 16 may include a heads-up display operable to project a visible message onto a windshield (not shown) of the vehicle 10. Further, the user interface device 16 may include one or more vibrators mounted to, for example, a steering wheel (not shown) and/or the driver's seat (not shown) to provide haptic feedback to the driver. Moreover, the user interface device 16 may include a speaker operable to generate a sound or audible message within the cabin 14, and/or a microphone operable to receive verbal commands from the driver.

The steering actuator 18 is operable to steer the vehicle 10 by moving linkages attached to front wheels (not shown) of the vehicle 10 and thereby turn the vehicle 10 right or left. The steering actuator 18 may be an electronically controlled steering gear. The acceleration actuator 20 is operable to accelerate the vehicle 10 by increasing the torque output of an engine (not shown) of the vehicle 10 and/or an electric motor (not shown) of the vehicle 10. Additionally or alternatively, the acceleration actuator 20 may accelerate the vehicle 10 by downshifting a transmission (not shown) of the vehicle 10. The acceleration actuator 20 may be or include an electronically controlled throttle, a motor control module, and/or a transmission gear actuator. The brake actuator 22 is operable to decelerate the vehicle 10 by rubbing against a component mounted to the front wheels of the vehicle 10 and/or rear wheels (not shown) of the vehicle 10. The brake actuator 22 may be or include one or more friction brakes (e.g., disc brakes).

The vehicle control module 24 performs several driver assist functions to assist the driver of the vehicle 10 based on inputs from sensors and cameras on the vehicle 10. The driver assist functions performed by the vehicle control module 24 include autonomous emergency braking (AEB), forward collision warning (FCW), adaptive cruise control (ACC), lane departure warning (LDW), lane keep assist (LKA), lane centering control (LCC), lane change warning (LCW), lane change assist (LCA), front cross traffic alert (FCTA), front cross traffic alert with braking (FCTB), rear cross traffic alert (RCTA), rear cross traffic alert with braking (RCTB) and highway pilot (HP). AEB involves applying the brake actuator 22 to decelerate the vehicle 10 to avoid or mitigate an impact with an object ahead of the vehicle 10. FCW involves controlling the user interface device 16 to generate a visible, audible, and/or tactile message notifying the driver of a potential impact with an object ahead of the vehicle 10.

ACC involves controlling the acceleration and brake actuators 20 and 22 to adjust the speed of the vehicle 10 to maintain a set speed selected by the driver and a following distance to another vehicle. LDW involves controlling the user interface device 16 to generate a visible, audible, and/or tactile message notifying the driver when the vehicle 10 is about to depart or has departed from a lane in which the vehicle 10 is travelling. LKA involves controlling the steering actuator 18 to maintain the vehicle 10 within the lane in which the vehicle 10 is travelling. LCC involves controlling the steering actuator 18 to maintain the centerline of the vehicle 10 aligned with the centerline of the lane. LCW involves controlling the user interface device 16 to generate a visible, audible, and/or tactile message notifying the driver of an object in a future path of the vehicle 10 during a lane change, such as in a blind spot of the vehicle 10. LCA involves controlling the steering, acceleration and brake actuators 18, 20, and 22 to adjust the speed and path of the vehicle 10 to perform a lane change maneuver when instructed to do so by the driver.

FCTA involves controlling the user interface device 16 to generate a visible, audible, and/or tactile message notifying the driver when another vehicle is crossing a forward path of the vehicle 10 and an impact is imminent. FCTB involves applying the brake actuator 22 to decelerate the vehicle 10 when another vehicle is crossing a forward path of the vehicle 10 and an impact is imminent. HP involves controlling the steering, acceleration, and brake actuators 18, 20, and 22 to adjust the speed and path of the vehicle 10 to complete a portion of a route selected by the driver that takes place in a geo-fenced area or access-controlled highway. RCTA involves controlling the user interface device 16 to generate a visible, audible, and/or tactile message notifying the driver when another vehicle is crossing a rearward path of the vehicle 10 and an impact is imminent. RCTB involves applying the brake actuator 22 to decelerate the vehicle 10 when another vehicle is crossing a reward path of the vehicle 10 and an impact is imminent.

The sensors include a left front short range radar (SRR) sensor 34, a right front SRR sensor 36, a left rear SRR sensor 38, a right rear SRR sensor 40, and a long range radar (LRR) sensor 42. The SRR sensors 34, 36, 38, 40 and the LRR sensor 42 detect objects near the vehicle 10. The left front SRR sensor 34 detects objects that are both within a field of view 35 of the left front SRR sensor 34 and within a certain range or distance of the left front SRR sensor 34. The right front SRR sensor 36 detects objects that are both within a field of view 37 of the right front SRR sensor 36 and within a certain range or distance of the right front SRR sensor 36.

The left rear SRR sensor 38 detects objects that are both within a field of view 39 of the left rear SRR sensor 38 and within a certain range or distance of the left rear SRR sensor 38. The right rear SRR sensor 40 detects objects that are both within a field of view 41 of the fight rear SRR sensor 40 and within a certain range or distance of the right rear SRR sensor 40. The LRR sensor 42 detects objects that are both within a field of view 43 of the LRR sensor 42 and within a certain range or distance of the LRR sensor 42. As their names indicate, the distances or ranges within which the SRR sensors 34, 36, 38, 40 are capable of detecting objects may be shorter than the distance or range within which the LRR sensor 42 is capable of detecting objects.

The SRR sensors 34, 36, 38, 40 and the LRR sensor 42 may detect objects near the vehicle 10 by emitting a radar wave and identifying the presence of an object when the radar wave bounces off the object and is received by the sensor that emitted it. The SRR sensors 34, 36, 38, 40 and the LRR sensor 42 may also output the period from the time when the radar wave is transmitted and the time when the radar wave it received by the sensor that emitted it. This period may be used to determine the distance between the vehicle 10 and objects detected by the SRR sensors 34, 36, 38, 40 and the LRR sensor 42. In various implementations, the vehicle 10 may include one or more lidar sensors (not shown) and/or one or more sonar sensors (not shown) in place of or in addition to the SRR sensors 34, 36, 38, 40 and/or the LRR sensor 42. The vehicle control module 24 may use inputs from the lidar and/or sonar sensors in the same way that the vehicle control module 24 uses inputs from the SRR sensors 34, 36, 38, 40 and the LRR sensor 42.

The cameras include a front camera 44, a rear camera 46, and a cabin camera 48. The front camera 44 captures a digital image of an area in front of the vehicle 10 within a field of view 45 of the front camera 44. The rear camera 46 captures a digital image of an area to the rear of the vehicle 10 within a field of view 47 of the rear camera 46. The cabin camera 48 captures a digital image of an area in the cabin 14 that is within a field of view 49 of the cabin camera 48.

The vehicle control module 24 also determines a distraction level of the driver of the vehicle 10 and adjusts the driver assist functions based on the driver distraction level. The vehicle control module 24 determines the driver distraction level based on the image captured by the cabin camera 48. For example, the vehicle control module 24 may identify features of the driver in the image such as the driver's eyes and hands, and determine the driver distraction level based on whether the driver's features are positioned, oriented, and moving in a manner consistent with attentive driving.

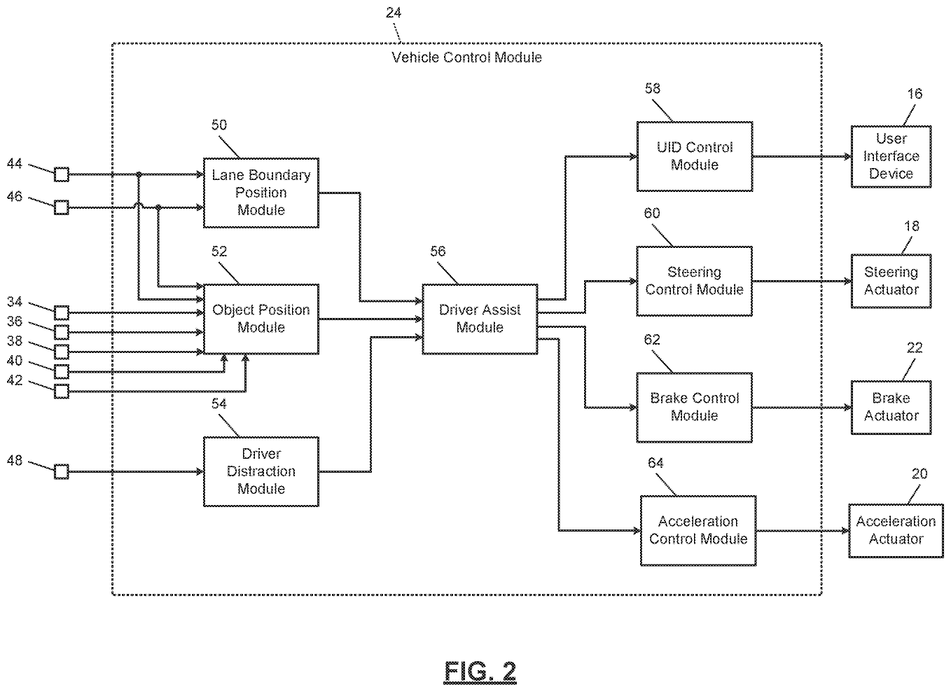

Referring now to FIG. 2, an example implementation of the vehicle control module 24 includes a lane boundary position module 50, an object position module 52, a driver position module 54, and a driver assist module 56. The lane boundary position module 50 determines the positions of the left and right boundaries of the lane in which the vehicle 10 is travelling. The lane boundary detection module 50 determines the lane boundary positions based on the image(s) captured by the front camera 44 and/or the rear camera 46. In one example, the lane position detection module 50 identifies the left and right lane boundaries in the image captured by the front camera 44 using edge detection techniques, and determines the positions of the lane boundaries relative to the vehicle 10 based on locations of the lane boundaries in the image. The lane boundary position module 50 outputs the lane boundary positions.

The lane boundary position module 50 may use a predetermined relationship between the number of pixels in the image and distance to determine the lane boundary positions relative to the vehicle 10 based on the locations of the lane boundaries in the image. The predetermined relationship may be obtained by positioning the vehicle 10 at known distances from lane boundaries and observing the number of pixels between the vehicle 10 and the lane boundaries in the image captured by the front camera 44. The predetermined relationship may be a two-dimensional coordinate system that relates the positions of pixels in the image captured by the front camera 44 to fore-aft and side-to-side distances between the vehicle 10 and the object depicted by the pixels.

The object position module 52 determines the positions of objects relative to the vehicle 10. The object position module 52 may determine the positions of objects ahead of the vehicle 10 and/or crossing a forward path of the vehicle 10 based on input(s) from the left front SRR sensor 34, the right front SRR sensor 36, the LRR sensor 42, and/or the front camera 44. The object position module 52 may determine the positions of objects rearward of the vehicle 10 and/or crossing a rearward path of the vehicle 10 based on input(s) from the left rear SRR sensor 38, the right rear SRR sensor 40, and/or the rear camera 46. Additionally or alternatively, the object position module 52 may determine the positions of objects rearward of the vehicle 10 and/or crossing a rearward path of the vehicle 10 based on input(s) from the sonar sensors of the vehicle 10. The object position module 52 outputs the positions of objects relative to the vehicle 10.

The object position module 52 may determine the position of an object detected by one of the SRR sensors 34, 36, 38, 40 or the LRR sensor 42 based on the period from the time when a radar wave is emitted from the sensor that detected the object and the time when the radar wave is received by that sensor. The object position module 52 may determine the position of an object detected by one of the aforementioned sensors based on the aforementioned period using a predetermined relationship between (i) time elapsed between radar wave transmission and receipt and (ii) distance. In addition, the object position module 52 may determine the position of an object detected by one of the SRR sensors 34, 36, 38, 40 or the LRR sensor 42 based on the direction in which the radar wave is emitted from the sensor that detected the object.

The object position module 52 may identify objects in the images captured by the front camera 44 and/or the rear camera 46 using edge detection techniques, and determine the positions of the objects relative to the vehicle 10 based on locations of the objects in the images. For example, the object position module 52 may use a predetermined relationship between the number of pixels in the images and distance to determine the object positions relative to the vehicle 10 based on the locations of the objects in the images. The predetermined relationship may be obtained by positioning the vehicle 10 at known distances from objects and observing the number of pixels between the vehicle 10 and the objects in the images captured by the front camera 44 and/or the rear camera 46. The predetermined relationship may be a two-dimensional coordinate system that relates the positions of pixels in the images captured by the front camera 44 and/or the rear camera 46 to fore-aft and side-to-side distances between the vehicle 10 and the objects depicted by the pixels.

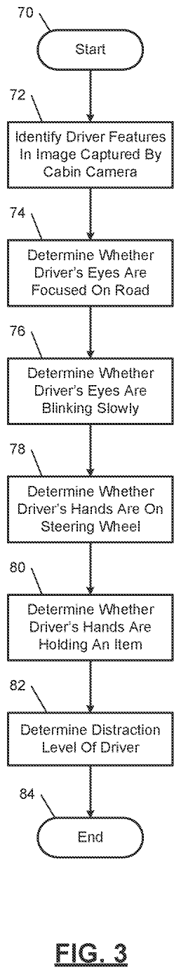

The driver distraction module 54 determines the distraction level of the driver of the vehicle 10 based on the image captured by the cabin camera 48. Examples of how the driver distraction module 54 may determine the driver distraction level based on the image captured by the cabin camera 48 are described below with respect to FIG. 3. The driver distraction module 54 outputs the driver distraction level.

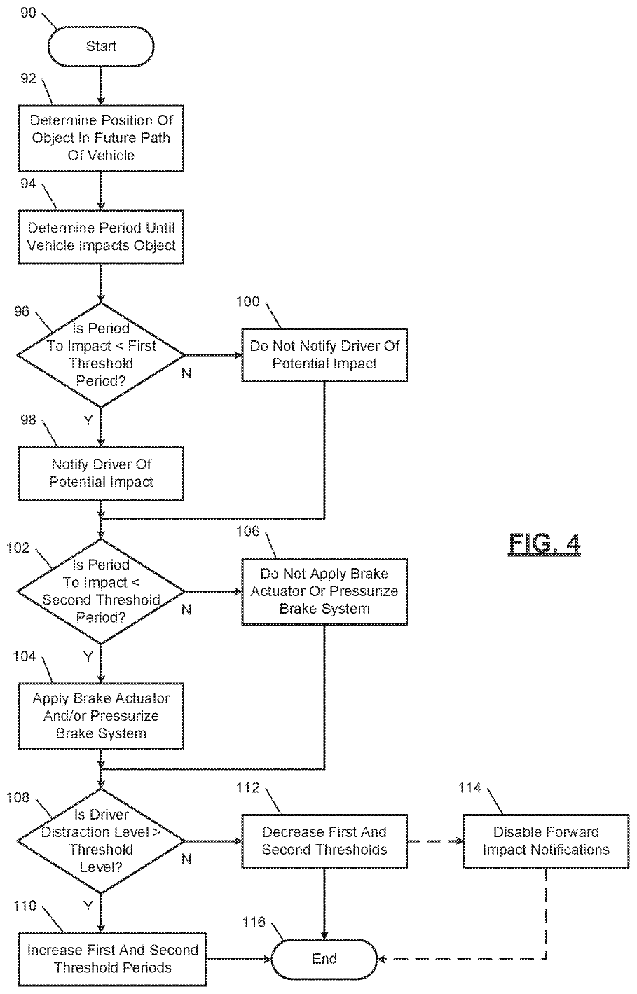

The driver assist module 56 performs the driver assist functions that are performed by the vehicle control module 24. Thus, the driver assist module 56 performs the AEB, FCW, ACC, LDW, LKA, LCC, LCW, LCA, FCTA, FCTB, RCTA, RCTB, and HP functions. The driver assist module 56 performs the driver assist functions based on the lane boundary positions from the lane boundary position module 50 and the object position(s) from the object position module 52. The driver assist module 56 also adjusts the driver assist functions based on the driver distraction level from the driver distraction module 54. Examples of how the driver assist module 56 may perform the driver assist functions and adjust the driver assist functions based on the driver distraction level is described below with respect to FIGS. 4 through 9.

The example implementation of the vehicle control module 24 shown in FIG. 2 further includes a user interface device (UID) control module 58, a steering control module 60, a brake control module 62, and an acceleration control module 64. The UID control module 58 controls the user interface device 16 to generate visible, audible, and/or tactile messages. The UID control module 58 controls the user interface device 16 by sending an electronic signal to the user interface device 16 indicating the type and content of the message to be generated by the user interface device 16.

The steering control module 60 controls the steering actuator 18 to steer the vehicle 10. The steering control module 60 controls the steering actuator 18 by sending an electronic signal to the steering actuator 18 instructing the steering actuator 18 to steer the vehicle 10 left or right, as well as the amount by which the steering actuator 18 is to steer the vehicle 10. In an example of the latter, the signal output by the steering control module 60 may indicate a target torque output of the steering actuator 18.

The brake control module 62 controls the brake actuator 22 to decelerate the vehicle 10. The brake control module 62 may control the brake actuator 22 by sending an electronic signal to the brake actuator 22 instructing the brake actuator 22 to decelerate the vehicle 10. The signal output from the brake control module 62 to the brake actuator 22 may also indicate the rate by which the brake actuator 22 is to decelerate the vehicle 10.

The acceleration control module 64 controls the acceleration actuator 20 to accelerate the vehicle 10. The acceleration control module 64 may control the acceleration actuator 20 by sending an electronic signal to the acceleration actuator 20 instructing the acceleration actuator 20 to accelerate the vehicle 10. The signal output from the acceleration control module 64 to the acceleration actuator 20 may also indicate the rate by which the acceleration actuator 20 is to accelerate the vehicle 10.

The driver assist module 56 performs the driver assist functions by sending instructions to the UID control module 58, the steering control module 60, the brake control module 62, and the acceleration control module 64. For example, the driver assist module 56 performs the driver assist functions that involve notifying a driver of a potential impact by sending an instruction (e.g., a signal) to the UID control module 58 to control the user interface device 16 to generate a visible, audible, and/or tactile message. In another example, the driver assist module 56 performs the driver assist functions that involve controlling a vehicle actuator to avoid or mitigate an impact by sending an instruction to the steering control module 60, the brake control module 62, and/or the acceleration control module 64. In another example, the driver assist module 56 performs the driver assist functions that involve controlling a vehicle actuator to perform driving tasks by sending an instruction to the steering control module 60, the brake control module 62, and/or the acceleration control module 64. In various implementations, the driver assist module 56 may include, or perform the functions of, the lane boundary position module 50, the object position module 52, the UID control module 58, the steering control module 60, the brake control module 62, and the acceleration control module 64.

Referring now to FIG. 3, an example method for determining the driver distraction level begins at 70. At 72, the driver distraction module 54 identifies features of the driver of the vehicle 10 in the image captured by the cabin camera 48. The features that may be identified include the eyes (or pupils) of the driver, the eyelids of the driver, the hands of the driver. In addition, the driver distraction module 54 may identify items in the image captured by the cabin camera 48 that may distract the driver, such as a cell phone or a cup.

The driver distraction module 54 may detect edges of the features or items in the image captured by the cabin camera 48, and determine the shapes and sizes of the features or items based on the detected edges. The driver distraction module 54 may compare the determined shapes and sizes to pairs of predetermined shapes and sizes corresponding to features such as eye pupils, eyelids, and hands. If the determined shapes and sizes are within a predetermined range of one of the pairs of predetermined shapes and sizes, the driver distraction module 54 may determine that the feature or item detected in the image is the feature or item corresponding to that pair.

The driver distraction module 54 may determine sizes of features or items in the image captured by the cabin camera 48, and the amount by which the features or items move, using a predetermined relationship between pixels in the image and distance. The predetermined relationship may be obtained by placing an object of a known size in the expected location of the driver's features, determining the number of pixels in the image that correspond to the object, and comparing that number to the size of the object. The driver distraction module 54 may observe the magnitude of movements of the feature or items over time in order to determine the speed of the movements.

At 74, the driver distraction module 54 determines whether the driver's eyes are focused on a road on which the vehicle 10 is travelling by, for example, determining whether the pupils of the driver's eyes are oriented toward the road. The driver distraction module 54 may adjust the driver distraction level to a lower level when the driver's eyes are focused on the road and adjust the driver distraction level to a higher level when the driver's eyes are not focused on the road. In various implementations, the driver distraction module 54 may determine whether the driver's eyes are focused on an object that is within a possible future path of the vehicle 10 and adjust the driver distraction level based on that determination. For example, the driver distraction module 54 may adjust the driver distraction level to a lower level when the driver's eyes are focused on the object and adjust the driver distraction level to a higher level when the driver's eyes are not focused on the object.

The driver distraction module 54 may determine whether the pupils of the driver's eyes are pointing toward the road based on the shape and/or orientation of the pupils in the image captured by the cabin camera 48. In various implementations, the vehicle 10 may include multiple ones of the cabin camera 48 to obtain images of the cabin 14 from different perspectives, and the driver distraction module 54 may generate a three-dimensional (3D) image of the cabin 14 based on the images. In these implementations, the driver distraction module 54 may determine whether the pupils of the driver's eyes are pointing toward the road based on the 3D orientation of the pupils.

At 76, the driver distraction module 54 determines whether the driver's eyes are blinking slowly, which indicates that the driver is drowsy. The driver distraction module 54 may adjust the driver distraction level to a lower level when the driver's eyes are not blinking slowly and adjust the driver distraction level to a higher level when the driver's eyes are blinking slowly. The driver distraction module 54 may determine whether the driver's eyes are blinking slowly by determining the speed at which the driver's eyelids move and comparing that speed to a predetermined speed for normal blinking. If the determined speed is less than the predetermined speed, the driver distraction module 54 determines that the driver's eyes are blinking slowly. Otherwise, the driver distraction module 54 determines that the driver's eyes are not blinking slowly.

At 78, the driver distraction module 54 determines whether the driver's hands are on the steering wheel of the vehicle 10. The driver distraction module 54 may adjust the driver distraction level to a lower level when the driver's hands are on the steering wheel and adjust the driver distraction level to a higher level when one or both of the driver's hands is/are not on the steering wheel. The driver distraction module 54 may identify the steering wheel in the image captured by the cabin camera 48 by comparing sizes, shapes, and locations of features or items in the image to a predetermined shape, size, and location of the steering wheel. The driver distraction module 54 may then determine whether objects in contact with and/or wrapped around the steering wheel corresponds to the driver's hands and, if so, determine that the driver's hands are on the steering wheel.

At 80, the driver distraction module 54 determines whether the driver's hands are holding a distracting item such as a cell phone or a cup. The driver distraction module 54 may adjust the driver distraction level to a lower level when the driver's hands are not holding a distracting item and adjust the driver distraction level to a higher level when the driver's hands are holding a distracting item. In various implementations, the driver distraction module 54 may use determinations made at 74 and 80 to determine whether the driver is exhibiting distracted behavior and increase the driver distraction level when that is the case. For example, if the driver's eyes are not focused on the road and the driver is holding a cell phone, the driver distraction module 54 may determine that the driver is using the cell phone and increase the driver distraction level.

At 82, the driver distraction module 54 determines the driver distraction level. The driver distraction module 54 may adjust the driver distraction level at 74, 76, 78, and 80, or determine driver distraction level after 74, 76, 78, and 80 are completed. The driver distraction module 54 may set the driver distraction level to a qualitative level (e.g., low, medium, high) or a quantitative level (e.g., an integer between 0 and 10) based on the determinations made at 74, 76, 78, and/or 80. In one example, the driver distraction module 54 increases the driver distraction level by 0 or 1 depending on whether a true or false determination is made at each of 74, 76, 78, and 80 (0 for true and 1 for false). In this example, the driver distraction level may range from 0 to 4. The method ends at 84. The driver distraction module 54 may repeatedly perform the method of FIG. 3 in an iterative manner when an ignition system (not shown) of the vehicle 10 is on and/or when the transmission of the vehicle 10 is in a forward or reverse gear.

Referring now to FIG. 4, an example method of performing the AEB, FCW, FCTA, FCTB, RCTA, and RCTB functions and adjusting these functions based on the driver distraction level begins at 90. At 92, the object position module 52 determines the position of an object in a possible future path of the vehicle 10. When performing the AEB or FCW functions, the driver assist module 56 is concerned with objects ahead of the vehicle 10, and therefore the object position module 52 may determine the position of such an object at 92. When performing the FCTA or FCTB functions, the driver assist module 56 is concerned with objects crossing a forward path of the vehicle 10, and therefore the object position module 52 may determine the position of such an object at 92. When performing the RCTA or RCTB functions, the driver assist module 56 is concerned with objects crossing a rearward path of the vehicle 10, and therefore the object position module 52 may determine the position of such an object at 92.

At 94, the driver assist module 56 determines a period until the vehicle 10 is likely to impact the object based on the position of the object relative to the vehicle 10 and the speed of the vehicle 10. For example, the driver assist module 56 may multiple the speed of the vehicle 10 by the distance between the vehicle 10 and the object to obtain the period to impact. The driver assist module 56 may execute 94 when performing the AEB or FCW functions and not execute 94 when performing the FCTA, FCTB, RCTA, or RCTB functions.

At 96, the driver assist module 56 determines whether the period to impact is less than a first threshold period. The driver assist module 56 may make this determination when performing the AEB or FCW functions. When the driver assist module 56 is performing the FCTA or FCTB functions, the driver assist module 56 may simply determine whether an object is crossing the forward path of the vehicle 10 at 96. When the driver assist module 56 is performing the RCTA or RCTB functions, the driver assist module 56 may simply determine whether an object is crossing the rearward path of the vehicle 10 at 96. If the period to impact is less than the first threshold period and/or an object is crossing the forward path of the vehicle 10, the method continues at 98. Otherwise, the method continues at 100.

At 98, the driver assist module 56 controls the user interface device 16 to generate a visible, audible, and/or tactile message notifying the driver of a potential impact with the object. The driver assist module 56 may control the user interface device 16 directly or by sending an instruction to the UID control module 58. At 100, the driver assist module 56 does not control the user interface device 16 to generate such a message.

At 102, the driver assist module 56 determines whether the period to impact is less than a second threshold period. The second threshold period may be less than the first threshold period. If the period to impact is less than the first threshold period, the method continues at 104. Otherwise, the method continues at 106. At 104, the driver assist module 56 applies the brake actuator 22 and/or pressurizes a hydraulic brake system (not shown) of the vehicle 10 (e.g., increase the pressure of hydraulic fluid in the brake system to an operating pressure). The driver assist module 56 may pressurize the brake system to decrease the response time of the brake actuator 22 when the brake actuator 22 is applied. The driver assist module 56 may pressurize the brake system by activating a pump of the brake system for a brief period (e.g., less than one second). The driver assist module 56 may control the brake actuator 22 and the brake system directly or by sending an instruction to the brake control module 62. At 106, the driver assist module 56 does not apply the brake actuator 22 or pressurize the brake system.

At 108, the driver assist module 56 determines whether the driver distraction level is greater than a threshold level. If the driver distraction level is a quantitative level (e.g., an integer between 0 and 10), the threshold level may be an integer (e.g., 3). If the distraction level is a qualitative level (e.g., low, medium, high), the threshold level may be one of the qualitative levels (e.g., low). For example, if the threshold level is low, the driver distraction level may be greater than the threshold level if the driver distraction level is medium or high. If the driver distraction level is greater than the threshold level, the method continues at 110. Otherwise, the method continues at 112.

At 110, the driver assist module 56 increases the first and second threshold periods. Alternatively, if the driver distraction level was greater than the threshold level during the last iteration of the method of FIG. 4, the driver assist module 56 may not adjust the first and second threshold periods at 110. Increasing the first and second threshold periods causes the driver assist module 56 to execute 98 and 104 sooner when an object is detected in the future path of the vehicle 10. The driver assist module 56 may increase the first and second threshold periods by amounts that are directly proportional to the amount by which the driver distraction level is greater than the threshold level (i.e., in an analog manner). Alternatively, the driver assist module 56 may increase the first and second threshold periods by a fixed amount regardless of the amount by which the driver distraction level is greater than the threshold level (i.e., in a digital manner). In one example, at 110, the driver assist module 56 increases the second threshold period from two seconds to three or four seconds.

At 112, the driver assist module 56 decreases the first and second threshold periods. Alternatively, if the driver distraction level was less than or equal to the threshold level during the last iteration of the method of FIG. 4, the driver assist module 56 may not adjust the first and second threshold periods at 112. The driver assist module 56 may decrease the first and second threshold periods at 112 in the same manner that the driver assist module 56 increases the first and second threshold periods at 110. For example, if the driver assist module 56 increases the first and second threshold periods in an analog manner at 110, the driver assist module 56 may decrease the first and second threshold periods in an analog manner at 112.

The method may continue from 112 to 114 before proceeding to 116, or the method may continue to 116 directly from 112. At 114, the driver assist module 56 disables forward impact notifications. In other words, when the driver distraction level is less than or equal to the threshold level, the driver assist module 56 does not execute 98 regardless of whether the period to impact is less than the first threshold period. The method ends at 116.

FIG. 4 shows 108 following 92, 94, 96, 98, 102, and 104. However, in various implementations, 108 and the steps thereafter (e.g., 110 or 112 and 114) may be performed in parallel with 92 and/or 94, before 96, in parallel with 98, before 102, and/or in parallel with 104. In addition, 108 and the steps thereafter may be repeatedly performed throughout the method of FIG. 4, such as between 94 and 96 and between 98 and 102.

The method of FIG. 4 may be repeatedly performed in an iterative manner in connection with the AEB and FCW functions when the transmission of the vehicle 10 is in a forward gear. The method of FIG. 4 may be repeatedly performed in an iterative manner in connection with the FCTA and FCTB functions when the transmission is in a forward gear and/or the driver indicates that he or she intends to turn the vehicle 10 left or right from one lane or road to another lane or road. The driver assist module 56 may determine whether the driver intends to turn the vehicle 10 based on a driver input such as an electronic signal that is generated when the driver moves a turn signal switch (not shown) of the vehicle 10. The method of FIG. 4 may be repeatedly performed in an iterative manner in connection with the RCTA and RCTB functions when the transmission is in a reverse gear.

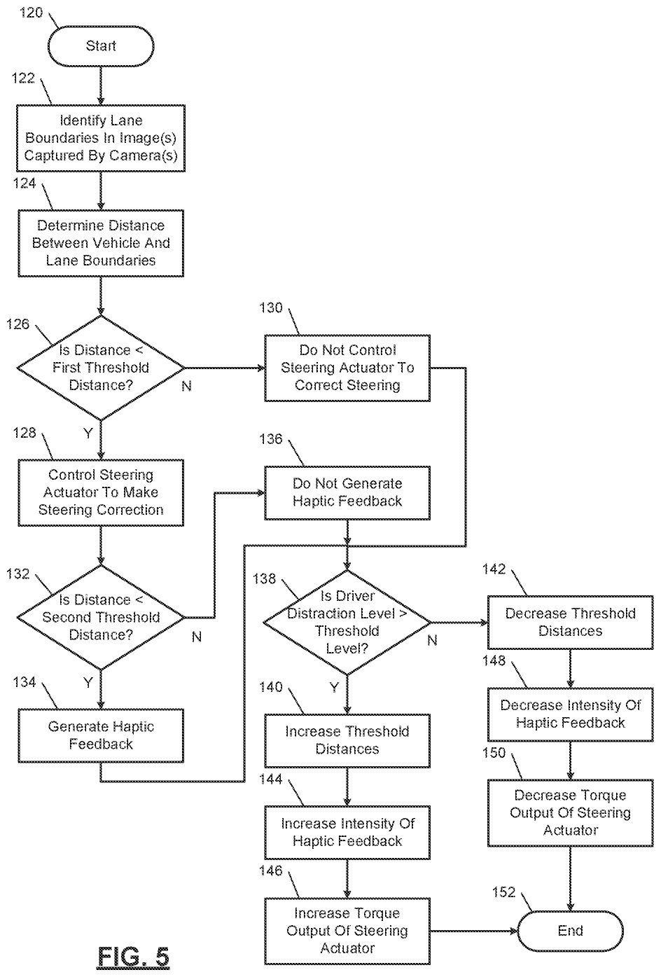

Referring now to FIG. 5, an example method of performing the LKA and LDW functions and adjusting these functions based on the driver distraction level begins at 120. At 122, the lane boundary position module 50 identifies, in the image captured by the front camera 44, the left and right lane boundaries of the lane in which the vehicle 10 is travelling. The lane boundary detection module 50 may determine the lane boundary positions based on a combination of (i) the image captured by the front camera 44, (ii) input(s) from the left front SRR sensor 34, the right front SRR sensor 36, and/or the LRR sensor 42, and/or (iii) the lidar sensors of the vehicle 10. At 124, the lane boundary position module 50 determines the distances between the left and right sides 30 and 32 of the vehicle 10 and the left and right lane boundaries, respectively.

At 126, the driver assist module 56 determines whether each of the distances between the vehicle 10 and the lane boundaries is less than a first threshold distance. If one or both of the distances between the vehicle 10 and the lane boundaries is/are less than the first threshold distance, the method continues at 128. Otherwise, the method continues at 130.

At 128, the driver assist module 56 controls the steering actuator 18 to make a steering correction (e.g., to steer the vehicle 10 away from the lane boundary to which the vehicle 10 is closest). The driver assist module 56 may control the steering actuator 18 directly or by sending an instruction to the steering control module 60. At 130, the driver assist module 56 does not control the steering actuator 18 to make a steering correction.

At 132, the driver assist module 56 determines whether each of the distances between the vehicle 10 and the lane boundaries is less than a second threshold distance (e.g., a distance within a range from zero to 1.5 feet). The second threshold distance may be less than the first threshold distance. If one or both of the distances between the vehicle 10 and the lane boundaries is/are less than the first threshold distance, the method continues at 134. Otherwise, the method continues at 136.

In various implementation, at 132, the driver assist module 56 may determine whether the vehicle 10 is likely to depart from the lane based on a trajectory and speed of the vehicle 10 (or a velocity vector of the vehicle 10). The driver assist module 56 may make this determination instead of or in addition to determining whether each of the distances between the vehicle 10 and the lane boundaries is less than the second threshold distance. The driver assist module 56 may determine the trajectory of the vehicle 10 based on the current position of the vehicle 10 relative to the lane boundaries and a steering angle of the vehicle 10.

If the vehicle 10 is likely to depart from the lane in which the vehicle 10 is travelling, the method continues at 134. Otherwise, the method continues at 136. At 134, the driver assist module 56 controls the user interface device 16 to generate haptic feedback (e.g., at the steering wheel) to notify the driver that the vehicle 10 is about to depart or has departed from the lane in which the vehicle 10 is travelling. At 136, the driver assist module 56 does not control the user interface device 16 to generate haptic feedback.

At 138, the driver assist module 56 determines whether the driver distraction level is greater than a threshold level such as the example threshold levels discussed above with reference to FIG. 4. If the driver distraction level is greater than the threshold level, the method continues at 140. Otherwise, the method continues at 142.

At 140, the driver assist module increases the first and second threshold distances. Increasing the threshold distances causes the driver assist module 56 to execute 128 and 134 sooner when the vehicle 10 starts to get closer to one of the lane boundaries. The driver assist module 56 may increase the first and second threshold distances by amounts that are directly proportional to the amount by which the driver distraction level is greater than the threshold level (i.e., in an analog manner). Alternatively, the driver assist module 56 may increase the first and second threshold distances by a fixed amount regardless of the amount by which the driver distraction level is greater than the threshold level (i.e., in a digital manner).

At 144, the driver assist module 56 increases the intensity of the haptic feedback generated by the user interface device 16. The driver assist module 56 may adjust the haptic feedback intensity by adjusting the instruction it sends to the UID control module 58 or adjusting a control signal it sends to the user interface device 16. At 146, the driver assist module 56 increases the torque output of the steering actuator 18, which increases the amount by which the steering actuator 18 steers the vehicle 10 away from the lane boundary to which the vehicle 10 is closest. The driver assist module 56 may not adjust the threshold distances, the haptic feedback intensity, or the steering actuator torque output at 140, 144, and 146 if the driver distraction level was greater than the threshold level during the last iteration of the method of FIG. 5.

At 142, the driver assist module decreases the first and second threshold distances. The driver assist module 56 may decrease the first and second threshold distances at 142 in the same manner that the driver assist module 56 increases the first and second threshold distances at 140. For example, if the driver assist module 56 increases the first and second threshold distances in an analog manner at 140, the driver assist module 56 may decrease the first and second threshold distances in an analog manner at 142.

At 148, the driver assist module 56 decreases the intensity of the haptic feedback generated by the user interface device 16. At 150, the driver assist module 56 decreases the torque output of the steering actuator 18, which decreases the amount by which the steering actuator 18 steers the vehicle 10 away from the lane boundary to which the vehicle 10 is closest. The driver assist module 56 may not adjust the threshold distances, the haptic feedback intensity, or the steering actuator torque output at 142, 148, and 150, respectively, if the driver distraction level was less than or equal to the threshold level during the last iteration of the method of FIG. 5. The method ends at 152. The method of FIG. 5 may be repeatedly performed in an iterative manner.

FIG. 5 shows 138 following 122, 124, 126, 128, and 132. However, in various implementations, 138 and the steps thereafter (e.g., 140, 144, and 146 or 142, 148, and 150) may be performed in parallel with 122 and/or 124, before 126, in parallel with 128, and/or before 132. In addition, 138 and the steps thereafter may be repeatedly performed throughout the method of FIG. 5, such as between 124 and 126 and between 128 and 132.

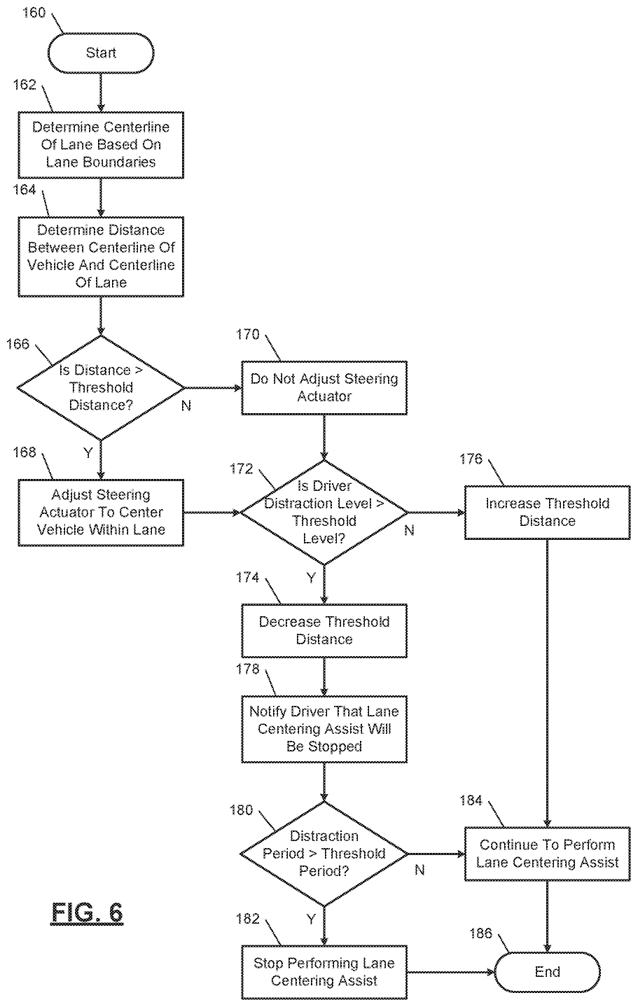

Referring now to FIG. 6, an example method of performing the LCC function and adjusting the LCC function based on the driver distraction level begins at 160. At 162, the driver assist module 56 determines the centerline of the lane in which the vehicle 10 is traveling based on the positions of the left and right boundaries of the lane from the lane boundary position module 50. For example, the driver assist module 56 may identify several midpoints between the left and right lane boundaries at various locations along a length of the lane, and identify the centerline of the lane as a line that extends through the midpoints.

At 164, the driver assist module 56 determines a distance between the centerline of the vehicle 10 and the centerline of the lane in which the vehicle 10 is travelling. The centerline of the vehicle 10 may be predetermined and stored in the driver assist module 56. The driver assist module 56 may determine the distance between the centerline of the vehicle 10 and the centerline of the lane at one fore-aft location along the vehicle 10, such as along a line that extends through centers of the front wheels of the vehicle 10.

At 166, the driver assist module 56 determines whether the distance between the vehicle centerline and the lane centerline is greater than a threshold distance. If the distance between the centerlines is greater than the threshold distance, the method continues at 168. Otherwise, the method continues at 170.

At 168, the driver assist module 56 adjusts the steering actuator 18 to center the vehicle 10 within the lane in which the vehicle 10 is traveling. In other words, the driver assist module 56 controls the steering actuator 18 to decrease the distance between the vehicle and lane centerlines. At 170, the driver assist module 56 does not adjust the steering actuator 18 to center the vehicle 10 within the lane in which the vehicle 10 is traveling.

At 172, the driver assist module 56 determines whether the driver distraction level is greater than a threshold level such as the example threshold levels discussed above with reference to FIG. 4. If the driver distraction level is greater than the threshold level, the method continues at 174. Otherwise, the method continues at 176.

At 174, the driver assist module 56 decreases the threshold distance. Decreasing the threshold distance causes the driver assist module 56 to execute 168 sooner when the centerline of the vehicle 10 moves away from the centerline of the lane. The driver assist module 56 may decrease the threshold distance by an amount that is directly proportional to the amount by which the driver distraction level is greater than the threshold level (i.e., in an analog manner). Alternatively, the driver assist module 56 may decrease the threshold distance by a fixed amount regardless of the amount by which the driver distraction level is greater than the threshold level (i.e., in a digital manner). The driver assist module 56 may not adjust the threshold distance at 174 if the driver distraction level was greater than the threshold level during the last iteration of the method of FIG. 6. At 178, the driver assist module 56 controls the user interface device 16 to notify the driver that the LCC function (or lane centering assist) will be disabled or stopped if the driver does not pay attention to the driving tasks.

At 176, the driver assist module 56 increases the threshold distance. The driver assist module 56 may increase the threshold distance at 176 in the same manner that the driver assist module 56 decreases the threshold distance at 174. For example, if the driver assist module 56 decreases the threshold distance in an analog manner at 174, the driver assist module 56 may increase the threshold distance in an analog manner at 176. The driver assist module 56 may not adjust the threshold distance at 176 if the driver distraction level was less than or equal to the threshold level during the last iteration of the method of FIG. 6.

At 180, the driver assist module 56 determines whether a distraction period (i.e., the period for which the distraction level is greater than the threshold period) is greater than a threshold period. If the distraction period is greater than the threshold period, the method continues at 182. Otherwise, the method continues at 184.

At 182, the driver assist module 56 stops performing the LCC function (or lane centering assist). In other words, the driver assist module 56 stops adjusting the steering actuator 18 to center the vehicle 10 within the lane in which the vehicle 10 is traveling regardless of whether the distance between the vehicle and lane centerlines is greater than the threshold distance. The driver assist module 56 may communicate with the driver via the user interface device 16 to confirm that the driver is ready to take control of steering the vehicle 10 before the driver assist module 56 stops performing the LCC function. At 184, the driver assist module 56 continues to perform the LCC function (or lane centering assist). The method ends at 186. The driver assist module 56 may repeatedly perform the method of FIG. 6 in an iterative manner.

FIG. 6 shows 172 following 162, 164, 166, and 168. However, in various implementations, 172 and the steps thereafter (e.g., 174 or 176) may be performed in parallel with 162 and/or 164, before 166, and/or in parallel with 168. In addition, 138 and the steps thereafter may be repeatedly performed throughout the method of FIG. 6, such as between 164 and 166 and in parallel with 168.

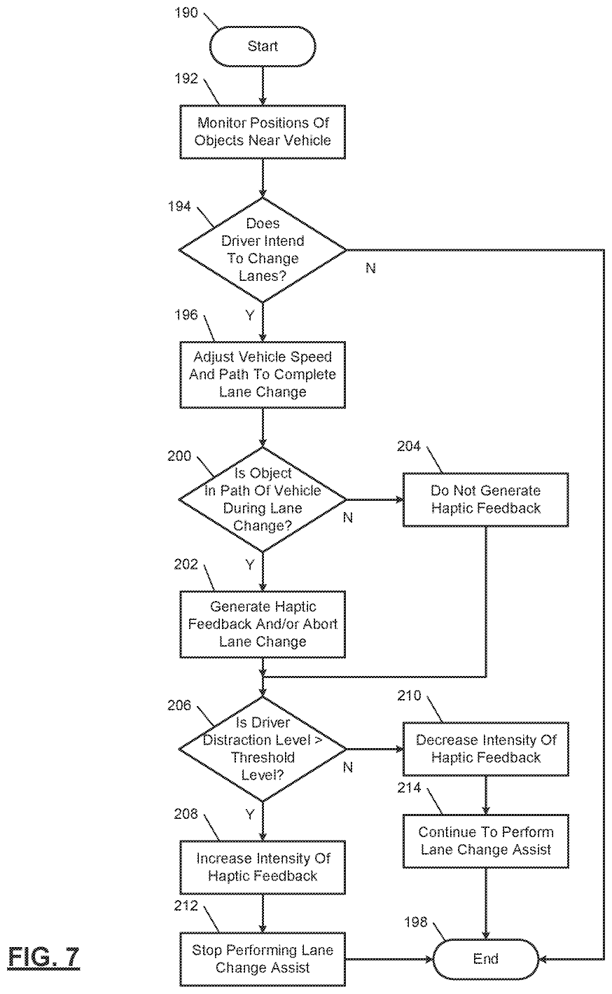

Referring now to FIG. 7, an example method of performing the LCW and LCA functions and adjusting these functions based on the driver distraction level begins at 190. At 192, the object position module 52 monitors (e.g., determines) the positions of objects near the vehicle 10. At 194, the driver assist module 56 determines whether the driver intends to change the lane in which the vehicle 10 is travelling. If the driver intends to change lanes, the method continues at 196. Otherwise, the method continues at 198. The driver assist module 56 may determine whether the driver intends to change lanes based on a driver input such as the electronic signal that is generated when the driver moves the turn signal switch of the vehicle 10.

At 196, the driver assist module 56 controls the acceleration or brake actuators 20 or 22, as well as the steering actuator 18, to adjust the speed and path of the vehicle 10 to complete the lane change that the driver intends to make (or would like to be made). The driver assist module 56 may control the acceleration actuator 20 directly or by sending an instruction to the acceleration control module 64. At 200, the driver assist module 56 determines whether an object is in the future path of the vehicle 10 during the intended or desired lane change. If the object is in the future path of the vehicle 10, the method continues at 202. Otherwise, the method continues at 204.

At 202, the driver assist module 56 controls the user interface device 16 to generate haptic feedback at, for example, the steering wheel of the vehicle 10 to notify the driver that an object is in the future path of the vehicle 10 during the intended or desired lane change. Additionally or alternatively, at 202, the driver assist module 56 may abort (i.e., stop performing) the lane change or, if the driver assist module 56 has not yet started performing the lane change, the driver assist module 56 may not perform the lane change at all. If the driver assist module 56 aborts the lane change, the driver assist module 56 may control the acceleration or brake actuators 20 or 22, as well as the steering actuator 18, to return the vehicle 10 to the lane from which the vehicle 10 was changing. At 204, the driver assist module 56 does not control the user interface device 16 to generate haptic feedback.

At 206, the driver assist module 56 determines whether the driver distraction level is greater than a threshold level such as the example threshold levels discussed above with reference to FIG. 4. If the driver distraction level is greater than the threshold level, the method continues at 208. Otherwise, the method continues at 210.

At 208, the driver assist module 56 increases the intensity of the haptic feedback generated by the user interface device 16. Alternatively, if the driver distraction level was greater than the threshold level during the last iteration of the method of FIG. 7, the driver assist module 56 may not adjust the haptic feedback intensity at 208. At 212, the driver assist module 56 stops performing the LCA function. In other words, the driver assist module 56 stops adjusting the speed and path of the vehicle 10 to complete the lane change that the driver intends to make (or would like to be made). If the lane change is already in progress, the driver assist module 56 may adjust the speed and path of the vehicle 10 to return the vehicle 10 to the lane from which the vehicle 10 was changing.

At 210, the driver assist module 56 decreases the intensity of the haptic feedback generated by the user interface device 16. Alternatively, if the driver distraction level was less than or equal to the threshold level during the last iteration of the method of FIG. 7, the driver assist module 56 may not adjust the haptic feedback intensity at 210. At 212, the driver assist module 56 continues to perform the LCA function. The method ends at 198. The method of FIG. 7 may be repeatedly performed in an iterative manner when the transmission of the vehicle 10 is in a forward gear.

FIG. 7 shows 206 following 192, 194, 196, 200, and 202. However, in various implementations, 206 and the steps thereafter (e.g., 208 and 212 or 210 and 214) may be performed in parallel with 192, before 194, in parallel with 196, before 200, and/or in parallel with 202. In addition, 206 and the steps thereafter may be repeatedly performed throughout the method of FIG. 7, such as between 196 and 200 and in parallel with 202.

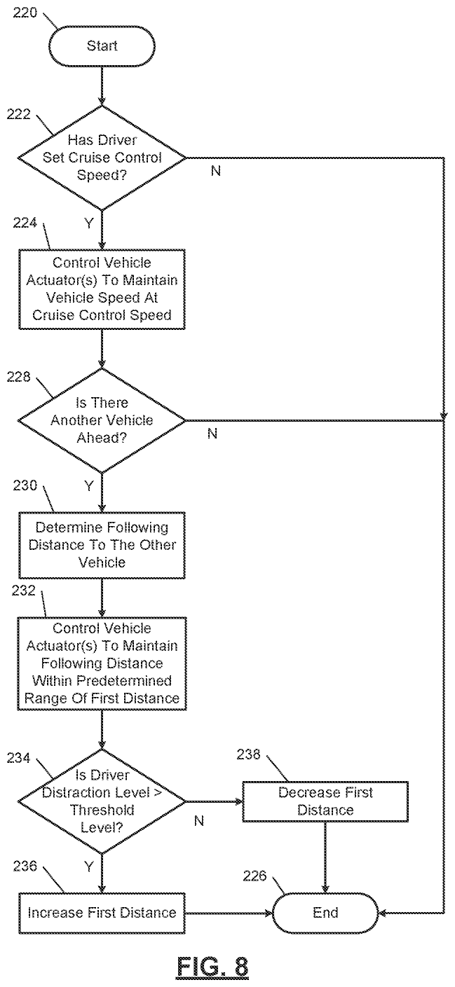

Referring now to FIG. 8, an example method of performing the ACC function and adjusting the ACC function based on the driver distraction level begins at 220. At 222, the driver assist module 56 determines whether the driver of the vehicle 10 has set a cruise control speed and a following distance or time gap using, for example, the user interface device 16. If the driver has set a cruise control speed and a following distance or time gap, the method continues at 224. Otherwise, the method continues at 226.

At 224, the driver assist module 56 controls the brake actuator 22 and/or the acceleration actuator 20 to maintain the speed of the vehicle 10 at the cruise control speed. The driver assist module 56 may control the speed of the vehicle 10 in a closed-loop manner using a measured speed of the vehicle 10 as a feedback. At 228, the driver assist module 56 determines whether there is another vehicle ahead of the vehicle 10 based on an input from the object position module 52. If there is another vehicle ahead of the vehicle 10, the method continues at 230. Otherwise, the method continues at 226.

At 230, the object position module 52 determines a following distance or time gap from the vehicle 10 to the other vehicle that is ahead of the vehicle 10. The object position module 52 may determine the following distance based on a period that elapses from a time when one of the SRR sensors 34, 36 or the LRR sensor 42 emit a radar wave to a time when the radar wave is received from the sensor that emitted it. The object position module 52 may also determine the following distance using the predetermined relationship between (i) time elapsed between radar wave transmission and receipt and (ii) distance. The object position module 52 may determine the time gap based on the following distance and the current speed of the vehicle 10.

At 232, the driver assist module 56 controls the acceleration actuator 20 and/or the brake actuator 22 to maintain the following distance of the vehicle 10 within a predetermined range of a first distance. The first distance may be the distance set by the driver. Alternatively, at 232, the driver assist module 56 controls the acceleration actuator 20 and/or the brake actuator 22 to maintain the actual time gap within a predetermined range of a first period. The first period may be the time gap set by the driver. At 234, the driver assist module 56 determines whether the driver distraction level is greater than a threshold level such as the example threshold levels discussed above with reference to FIG. 4. If the driver distraction level is greater than the threshold level, the method continues at 236. Otherwise, the method continues at 238.

At 236, the driver assist module 56 increases the first distance or the first period. The driver assist module 56 may increase the first distance or the first period by an amount that is directly proportional to the amount by which the driver distraction level is greater than the threshold level (i.e., in an analog manner). Alternatively, the driver assist module 56 may increase the first distance or the first period by a fixed amount regardless of the amount by which the driver distraction level is greater than the threshold level (i.e., in a digital manner). The driver assist module 56 may not adjust the first distance or the first period at 236 if the driver distraction level greater than the threshold level during the last iteration of the method of FIG. 8.

At 238, the driver assist module 56 decreases the first distance or the first distance. The driver assist module 56 may decrease the first distance or the first period in the same manner that the driver assist module 56 increases the first distance or the first period at 236. For example, if the driver assist module 56 increases the first distance or the first period in an analog manner at 236, the driver assist module 56 may decrease the first distance or the first period in an analog manner at 238. The driver assist module 56 may not decrease the first distance or the first period to a value that is less than that set by the driver. The driver assist module 56 may not adjust the first distance or the first period at 238 if the driver distraction level less than or equal to the threshold level during the last iteration of the method of FIG. 8. The method ends at 226. The method of FIG. 8 may be repeatedly performed in an iterative manner when the transmission of the vehicle 10 is in a forward gear.

FIG. 8 shows 234 following 222, 224, 228, 230, and 232. However, in various implementations, 234 and the steps thereafter (e.g., 236 or 238) may be performed before 222, in parallel with 224, before 228, and/or in parallel with 230 and/or 232. In addition, 234 and the steps thereafter may be repeatedly performed throughout the method of FIG. 8, such as between 230 and 232 and in parallel with 232.

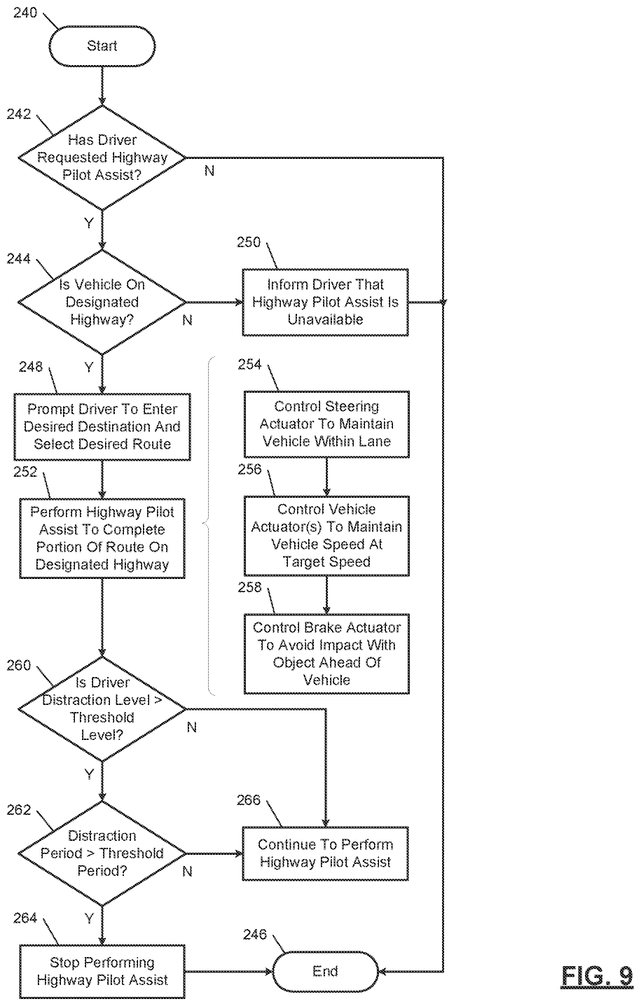

Referring now to FIG. 9, an example method of performing the HP function and adjusting the HP function based on the driver distraction level begins at 240. At 242, the driver assist module 56 determines whether the driver of the vehicle 10 has requested that the HP function (or highway pilot assist) be performed. In one example, the driver requests that the HP function be performed by touching a touchscreen of the user interface device 16 at a certain location. If the driver has requested that the HP function be performed, the method continues at 244. Otherwise, the method continues at 246.

At 244, the driver assist module 56 determines whether the vehicle 10 is on an access-controlled or designated highway. If the vehicle 10 is on an access-controlled or designated highway, the method continues at 248. Otherwise, the method continues at 250. At 248, the driver assist module 56 controls the user interface device 16 to prompt the driver of the vehicle 10 enter a desired destination and select a desired route. At 250, the driver assist module 56 controls the user interface device 16 to inform the driver that the HP function (or highway pilot assist) is unavailable.

At 252, the driver assist module 56 performs the HP function (or highway pilot assist) to complete the portion of the route selected by the driver that takes place on the designated highway. Performing the HP function involves executing 254, 256, and 258. At 254, the driver assist module 56 controls the steering actuator 18 to maintain the vehicle 10 within the lane in which the vehicle 10 is travelling. At 256, the driver assist module 56 controls the acceleration actuator 20 and/or the brake actuator 22 to maintain the speed of the vehicle 10 at a target speed (e.g., a speed limit for the designate highway that may be stored in the driver assist module 56). At 258, the driver assist module 56 controls the brake actuator 22 to decelerate the vehicle 10 and thereby avoid an impact between the vehicle 10 and an object ahead of the vehicle 10.

At 260, the driver assist module 56 determines whether the driver distraction level is greater than a threshold level such as the example threshold levels discussed above with reference to FIG. 4. If the driver distraction level is greater than the threshold level, the method continues at 262. Otherwise, the method continues at 264. Before continuing to 262, the driver assist module 56 may control the user interface device 16 to notify the driver that the HP function (or highway pilot assist) will be disabled or stopped if the driver does not pay attention to the driving tasks.

At 262, the driver assist module 56 determines whether the distraction period (i.e., the period for which the distraction level is greater than the threshold period) is greater than the threshold period. If the distraction period is greater than the threshold period, the method continues at 264. Otherwise, the method continues at 266.

At 264, the driver assist module 56 stops performing the HP function (or highway pilot assist). The driver assist module 56 may communicate with the driver via the user interface device 16 to confirm that the driver is ready to take control of the vehicle 10 before the driver assist module 56 stops performing the HP function (or highway pilot assist). At 266, the driver assist module 56 continues to perform the HP function (or highway pilot assist). The method ends at 246. The method of FIG. 8 may be repeatedly performed in an iterative manner when the transmission of the vehicle 10 is in a forward gear.

FIG. 9 shows 260 following 242, 244, 248, and 252. However, in various implementations, 260 and the steps thereafter (e.g., 262 and 264 or 266) may be performed in parallel with 242, before 244, and/or in parallel with 248 and/or 252. In addition, 260 and the steps thereafter may be repeatedly performed throughout the method of FIG. 9, such as multiple times in parallel with 252.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
a driver distraction module configured to determine a distraction level of a driver of a vehicle; and
a driver assist module configured to:
monitor a parameter including at least one of:
a position of an object relative to the vehicle; and
a position of at least one boundary of a lane in which the vehicle is travelling;
based on the monitored parameter, at least one of:
adjust an actuator of the vehicle to at least one of (i) steer the vehicle and (ii) decelerate the vehicle; and
control a user interface device of the vehicle to at least one of (i) generate a first message notifying the driver of the object and (ii) generate a second message notifying the driver of a possible departure of the vehicle from the lane; and
based on the driver distraction level, adjust at least one of (i) a time at which the vehicle actuator is adjusted based on the monitored parameter, (ii) an amount by which the vehicle actuator is adjusted based on the monitored parameter, (iii) a time at which the user interface device generates at least one of the first and second messages; (iv) the first message; and (v) the second message.

2. The system of claim 1 wherein the driver assist module is configured to:
monitor the position of an object relative to the vehicle;
based on the object position, at least one of:
adjust the vehicle actuator to decelerate the vehicle; and
control the user interface device to generate the first message; and
based on the driver distraction level, adjust at least one of (i) the time at which the vehicle actuator is adjusted based on the object position, (ii) the amount by which the vehicle actuator is adjusted based on the object position, and (iii) the time at which the user interface device generates the first message.

3. The system of claim 2 wherein the driver assist module is configured to:
based on the object position, determine a first period between a current time and a future time when the vehicle is likely to impact the object;
when the first period is less than a threshold period, at least one of:
adjust the vehicle actuator to decelerate the vehicle; and
control the user interface device to generate the first message; and
adjust the threshold period based on the driver distraction level.

4. The system of claim 3 wherein when the first period is less than the threshold period, the driver assist module is configured to at least one of:
apply a brake actuator of the vehicle to decelerate the vehicle; and
increase a pressure within a brake system of the vehicle to an operating pressure.

5. The system of claim 3 wherein the driver assist module is configured to control the user interface device to generate the first message when the first period is less than the threshold period.

6. The system of claim 3 wherein the driver assist module is configured to:
increase the threshold period when the driver distraction level is greater than a threshold level; and
decrease the threshold period when the driver distraction level is less than or equal to the threshold level.

7. The system of claim 2 wherein the driver assist module is configured to:
determine a following distance between the vehicle and the object;
control the vehicle actuator to adjust a speed the vehicle in order to maintain the following distance within a predetermined range of a first distance; and
adjust the first distance based on the driver distraction level.

8. The system of claim 7 wherein the driver assist module is configured to:
increase the first distance when the driver distraction level is greater than a threshold level; and
decrease the first distance when the driver distraction level is less than or equal to the threshold level.

9. The system of claim 1 wherein the driver assist module is configured to:
determine a first distance between the vehicle and the at least one boundary of the lane in which the vehicle is travelling;
when the first distance is less than a threshold distance, at least one of:
adjust a steering actuator of the vehicle to steer the vehicle; and
control the user interface device to generate the second message; and
based on the driver distraction level, adjust at least one of (i) the threshold distance, (ii) the amount by which the steering actuator is adjusted when the first distance is less than the threshold distance, and (iii) the second message.

10. The system of claim 9 wherein the driver assist module is configured to adjust the steering actuator to steer the vehicle when the first distance is less than the threshold distance.

11. The system of claim 10 wherein the driver assist module is configured to:
increase a torque output of the steering actuator when the driver distraction level is greater than a threshold level; and
decrease the torque output of the steering actuator when the driver distraction level is less than or equal to the threshold level.

12. The system of claim 9 wherein the driver assist module is configured to control the user interface device to generate the second message when the first distance is less than the threshold distance.

13. The system of claim 12 wherein:
the second message includes haptic feedback; and
the driver assist module is configured to adjust an intensity of the haptic feedback based on the driver distraction level.

14. The system of claim 9 wherein the driver assist module is configured to:
increase the threshold distance when the driver distraction level is greater than a threshold level; and
decrease the threshold distance when the driver distraction level is less than or equal to the threshold level.

15. The system of claim 1 wherein the driver assist module is configured to:
determine a centerline of the lane in which the vehicle is travelling based on the position of a left boundary of the lane and the position of a right boundary of the lane;
determine a first distance between a longitudinal centerline of the vehicle and the centerline of the lane;
perform a lane centering assist by controlling a steering actuator of the vehicle to steer the vehicle to maintain the first distance within a threshold distance; and
based on the driver distraction level, at least one of:
adjust the threshold distance;
control the user interface device of the vehicle to generate a third message notifying the driver that performance of the lane centering assist will be stopped if the driver distraction level is not decreased; and
stop performing the lane centering assist.

16. The system of claim 15 wherein the driver assist module is configured to:
decrease the threshold distance when the driver distraction level is greater than a threshold level; and
increase the threshold distance when the driver distraction level is less than or equal to the threshold level.

17. The system of claim 15 wherein the driver assist module is configured to:
control the user interface device to generate the third message when the driver distraction level is greater than a threshold level; and
stop performing the lane centering assist when the driver distraction level remains greater than the threshold level for a threshold period after the third message is generated.

18. The system of claim 1 wherein the driver assist module is configured to:
determine, based on an input from the driver, when the driver intends to change the lane in which the vehicle is travelling from a first lane to a second lane;
determine whether the object is within a future path of the vehicle during the lane change;
perform a lane change assist by controlling the vehicle actuator to complete the lane change when the object is not within the future path of the vehicle; and
at least one of (i) refrain from performing the lane change assist and (ii) stop preforming the lane change assist when the driver distraction level is greater than a threshold level.

19. The system of claim 1 wherein the driver assist module is configured to:
determine, based on an input from the driver, when the driver intends to change the lane in which the vehicle is travelling from a first lane to a second lane;
determine whether the object is within a future path of the vehicle during the lane change;
control the user interface device to generate the first message notifying the driver of the object when the object is within the future path of the vehicle, wherein the first message includes haptic feedback; and
adjust an intensity of the haptic feedback based on the driver distraction level.

20. The system of claim 1 wherein the driver assist module is configured to:
perform a highway pilot assist by:
controlling a steering actuator of the vehicle to maintain the vehicle within the lane of a highway;
controlling an acceleration actuator of the vehicle to maintain a speed of the vehicle at a target speed; and
controlling a brake actuator of the vehicle to avoid an impact with the object; and
based on the driver distraction level, at least one of:
control the user interface device of the vehicle to generate a third message notifying the driver that performance of the highway pilot assist will be stopped if the driver distraction level is not decreased; and
stop performing the highway pilot assist.
